(19) United States
(12) Patent Application Publication
(10) Pub. No.: US 2020/0077375 A1
(43) Pub. Date: Mar. 5, 2020

(54) NON-ORTHOGONAL SIGNALING FOR RADIO ACCESS NETWORKS

(71) Applicant: Telefonaktiebolaget LM Ericsson (publ), Stockholm (SE)

(72) Inventors: Efthymios STATHAKIS, STOCKHOLM (SE); Robert BALDEMAIR, SOLNA (SE); Ali BEHRAVAN, STOCKHOLM (SE)

(21) Appl. No.: 16/613,536

(22) PCT Filed: May 26, 2017
(86) PCT No.: PCT/SE2017/050566

§ 371 Date: Nov. 14, 2019

(51) Int. Cl. H04W 72/04; H04L 5/00

(52) U.S. Cl. CPC H04W 72/044; H04L 5/0007

(57) ABSTRACT

There is disclosed a method of operating a radio node in a radio access network. The method comprises communicating based on a configuration, the configuration associating each signaling of a group of signalings with a subset of radio resources, each subset being a subset of a set of radio resources; wherein a signaling associated to a subset of radio resources is associated to transmission that is non-orthogonal to transmission of other signaling associated to the same subset.

The disclosure also pertains to related methods and devices.

### TECHNICAL FIELD

The present disclosure pertains to wireless communication technology, in particular in the context of a Radio Access Network (RAN), for example a 5G (5th Generation) network like 3GPP (3rd Generation Partnership Project, a standardisation organization) NR (New Radio).

### BACKGROUND

In radio access network, resources (in particular time/frequency resources) are usually distributed for communication with a plurality of devices. To avoid different communication interfering with each other, they may be distributed (scheduled) on different time/frequency resources, and/or be orthogonalized. For example, OFDM/A (Orthogonal Frequency Division Multiplexing/Multiple Access) schemes as used, e.g. in LTE (Long Term Evolution, a 3GPP 4G standard), may comprise an orthogonal distribution of communications (or signaling) in frequency. In particular, for communications scheduled to share time/frequency resources, orthogonal approaches may be used to limit interference and/or for reliable reception. However, in any given system, only a limited number of elements in a distribution are orthogonal. Accordingly, not all users/communications may be able to be orthogonalised, and/or undesired control signaling overhead may be needed to manage the orthogonalisation.

Improved ways of handling multiple signalings (e.g., multiple communications and/or multiple users) are desired, which overcome such issues with orthogonalised signaling.

### SUMMARY

It is an object of this disclosure to provide approaches allowing improved handling of multiple signalings/communications.

The approaches are particularly advantageously implemented in a 5th Generation (5G) telecommunication network or 5G radio access technology or network (RAT/RAN), in particular according to 3GPP (3^{rd} Generation Partnership Project, a standardisation organization). A suitable RAN may in particular be a RAN according to NR, for example release 15 or later.

Accordingly, there is disclosed a method of operating a radio node in a radio access network (RAN). The method comprises communicating based on a configuration. The configuration associates each signaling of a group of signalings with a subset of radio resources, each subset being a subset of a set of radio resources. A signaling associated to a subset of radio resources is associated to transmission that is non-orthogonal to transmission of other signaling associated to the same subset. The method may comprise determining the configuration, e.g. scheduling signaling and/or radio nodes for transmission and/or reception accordingly.

Moreover, a radio node for a radio access network is discussed. The radio node is adapted for communicating based on a configuration. The configuration associates each signaling of a group of signalings with a subset of radio resources. Each subset is a subset of a set of radio resources. A signaling associated to a subset of radio resources is associated to transmission that is non-orthogonal to transmission of other signaling associated to the same subset. The radio node may comprise, and/or be adapted for utilising, processing circuitry and/or radio circuitry, in particular a receiver and/or transmitter and/or transceiver, for such communicating. Alternatively, or additionally, the radio node may comprise a communicating module for such communicating. The radio node may be adapted for determining the configuration, e.g. by utilising its circuitry, and/or may comprise a corresponding determining module.

Communicating may generally comprise transmitting and/or receiving. Alternatively, or additionally, communicating may comprise configuring one or more other radio node/s (e.g., one or more transmitting radio nodes) based on the configuration. Such configuring may for example indicate to a radio node which subset and/or transmission parametrisation to use for signaling. It should be noted that the configuration data transmitted to a radio node for configuring may be based on the configuration, e.g. correspond to it partly, in particular to a part of the configuration pertaining to the configured node. In some variants, such a part may indicate resource/s and/or parametrisation relevant for signaling by or from the configured node.

Signaling may generally be scheduled signaling or actual signaling. Scheduled signaling may in particular be signaling the configuration pertains to. Each (actual) signaling may be considered to represent transmission, as even when receiving signaling, this signaling has to be transmitted (by another node, for example).

More than one signaling may be associated to a subset, in particular signaling associated to different radio nodes may be associated to the same subset. Such association may be based on operation conditions, e.g. transmission conditions, and/or be based on channel monitoring and/or reporting, e.g. CQI and/or CSI (Channel Quality Information and/or Channel State Information).

There may be considered a method (e.g., referred to as transmitting method) of operating a radio node, e.g. a transmitting radio node, in a radio access network. The method comprises transmitting signaling based on a transmission configuration. The transmission configuration indicates a subset of radio resources for transmitting the signaling. The subset is one subset of a plurality of subsets of a set of radio resources. Furthermore, the transmission configuration indicates a transmission parametrisation for the signaling. The transmission parametrisation is one of a set of transmission parametrisations, wherein at least two of the transmission parametrisations are non-orthogonal to each other.

A radio node for a radio access network may be considered, which may be referred to as transmitting radio node. The radio node is adapted for transmitting signaling based on a transmission configuration. The transmission configuration indicates a subset of radio resources for transmitting the signaling. The subset is one subset of a plurality of subsets of a set of radio resources. Furthermore, the transmission configuration indicates a transmission parametrisation for the signaling. The transmission parametrisation is one of a set of transmission parametrisations, wherein at least two of the transmission parametrisations are non-orthogonal to each other. The (transmitting) radio node may comprise, and/or be adapted to utilise, processing circuitry and/or radio circuitry, in particular a transmitter and/or receiver, for such transmitting. Alternatively, or additionally, the radio node may comprise a transmitting module for such transmitting.

Transmission of signaling may be considered non-orthogonal to transmission of other signaling if non-orthogonal transmission parameters/parametrisation are associated to the transmissions.

In some variants, a parameter or parametrisation may be considered to be associated to a transmission if the transmission is based (and/or scheduled or configured to be based) on the parameter and/or parametrisation, e.g. utilises or scheduled or configured the parameter or parametrisation. A configuration may be considered to associate resource/s (e.g., a set or subset) and/or a parametrisation and/or parameter to signaling or transmission of signaling if it configures and/or schedules and/or instructs and/or assumes that the association holds, and/or the transmission uses, the resource/s and/or parametrisation/parameter/s.

A parametrisation may comprise one or more parameters. A transmission parametrisation may comprise and/or indicate one or more transmission parameters, e.g. pertaining to phase and/or weight (e.g., regarding amplitude and/or power and/or pertaining to real and/or imaginary carrier components) and/or timing (e.g., in relation to beamforming) of transmission. A transmission parametrisation may pertain to a specific signaling. It may be considered that a transmission parametrisation provides and/or indicate a parametrisation vector for one or more resource groups. A resource group may comprise and/or indicate one or more subcarriers and/or one or more symbol time intervals, and/or may comprise one or more resource elements. One specific example of a resource group is a (single) resource element. A parametrisation vector may indicate how a symbol group of a signaling is to be transmitted over and/or on the resource group it pertains to. For different resource groups, a parametrisation vector may be considered to indicate different weights and/or phases. A parametrisation vector may be considered to comprise one or more group vectors, each group vector indicating weight and/or phase for the symbol group to be transmitted on the resource group.

A parametrisation vector may in particular indicate weight and/or phase for a symbol group and/or transmission on a resource group. In some variants, a parametrisation vector may pertain to one symbol and a plurality of resource elements (each element representing a different resource group), wherein the symbol may be transmitted (and/or be scheduled to be transmitted) on each of the resource elements. Generally, a symbol group may be transmitted on each of the corresponding resource groups, based on the parametrisation vector.

A symbol group may comprise one or more symbols. A symbol may in particular represent a modulate symbol, e.g. after a QAM (Quadrature Amplitude Modulation) or other modulation has been performed, for example on data associated to the symbol and/or carrier by the symbol.

A signaling may pertain to a specific transmitting source of the signaling, e.g. a specific radio node. A radio node may be the source of different signalings, e.g. a network node. A signaling may comprise one or more symbols, and/or pertain to a specific channel and/or data stream and/or symbol stream and/or radio node (e.g., transmitting and/or target node).

Generally, different subsets, and/or at least two subsets, of radio resources may be orthogonal to each other. Orthogonal resources may be resources that do not overlap in time and/or frequency. In particular, orthogonal subsets may comprise, and/or comprise of, different resource elements or resource groups.

Radio resources generally may be time/frequency resources. In particular, resource groups and/or resource elements may represent time/frequency resources. A set of radio resources may comprise a set of resource elements and/or resource groups. In some variants, a set or subset (in some cases, each subset) of radio resources may comprise resources that are continuous or contiguous in time and/or frequency, e.g. cover a continuous or contiguous time interval (e.g., a transmission timing structure, like a slot or subframe or mini-slot), and/or a continuous or contiguous frequency interval, e.g. a number of subcarriers, e.g. 10 or in particular 12 subcarriers. A subset of resources may correspond to a resource block, and/or the number of subcarriers in a resource block, and/or a part thereof, e.g. an integer I multiple of 2 or 3 subcarriers (I equal to, or larger than, 1).

A symbol of a signaling may be spread over a plurality of resource elements, e.g. according to a transmission parametrisation. Spreading may be considered to comprise repeating the symbol for each resource element, according to the transmission parametrisation, in particular a corresponding parametrisation vector. For each resource element, the symbol may be multiplied by a group vector. A group vector may in general be considered a part of a parametrisation vector pertaining to a specific resource element (as a representing of a resource group in this variant), and/or to indicate weight and/or phase for the resource element. The symbol may be multiplied and/or transformed according to the group vector and/or the weight and/or phase for transmission on the associated resource element. A symbol may be spread in time on the same symbol time interval. The group vectors of a parametrisation vector may be different from each other. Parametrisation vectors associated to different subsets of radio resources may be (pairwise) the same, or may be different. Alternatively, the set of parametrisation vectors associated to signalings on one subset may be equal to, or different to, the set of parametrisation vectors associated to signalings on a different subset.

For different resource elements/resource groups, the group vectors of a parametrisation vector may be different, or in some cases the same. Group vectors for symbols/symbol groups associated to different signaling on the same resource group/resource element may be non-orthogonal to each other. Transmissions with non-orthogonal group vectors may be considered non-orthogonal.

Transmission and/or group vectors and/or a transmission parametrisation (or transmission configuration) and/or parametrisation vector may be considered non-orthogonal, if the associated vectors do not follow an orthogonality relation, e.g. their products (e.g., scalar products or modified, e.g. normalized scalar products, or different products), are not zero, or are within a predefined interval around zero, which may be considered to effectively be zero. Generally, there may be predefined and/or configured a set of transmission parametrisations, and/or parametrisation vectors (which may also be referred to as transmission vectors) and/or group vectors, which may be non-orthogonal, in particular at least pairwise orthogonal. Non-orthogonality may in general be considered to be implemented if group vectors pertaining to different symbols or symbol groups on the same resource groups and/or resource elements are non-orthogonal.

In some variants, a transmission parametrisation may be indicated by a vector, e.g., a parametrisation vector, which may be covering one or more subsets (of radio resources). A transmission parametrisation may be considered to cover a subset if it provides group vectors for each resource group in a subset. A subset may comprise a plurality of resource groups, e.g. a plurality of resource elements.

It may be considered that a group vector is zero (e.g., for weight, or for all components) for a specific resource group, e.g. a resource element.

Generally, a parametrisation vector, and/or one or more group vectors, may be configured to a radio node, e.g. for transmission, or reception.

Different subsets of resources may in particular be different (in particular, non-overlapping) in frequency domain. Subsets share a border in frequency space, e.g. pairwise.

A configuration, in particular a transmission configuration may indicate frequency hopping and/or time hopping of a symbol transformed by a group vector, e.g. mapping the symbol to a different resource element, for example in the same transmission timing structure. Such hopping may represent exchanging transformed symbols of different signalings (of the same transmitting radio node).

Communicating may comprise receiving the signalings utilising a MAP receiver. Other receivers able to determine/separate/detect non-orthogonal transmissions (e.g., individually, or in order) may be considered, for example MMSE receivers.

A set of radio resources may generally correspond to one or more resource blocks, in particular physical resource block/s; and/or a subset may pertain to a part thereof, e.g. as described herein, in particular to a part of a resource block. A subset may comprise a plurality of resource groups, which may comprise one or more resource elements. For example, a subset may comprise 2, 3 or 4 resource elements, each of which may represent one (different) resource group. A parametrisation vector may comprise a group vector (spreading vector) for each subset and/or resource group and/or for each symbol of a signaling. For subset/s a symbol is not transmitted on, the corresponding vector/s may be zero. The subsets for a signaling/symbol may be in the same resource block, or may be distributed between different resource blocks.

A (physical) resource block may be considered to represent 12 (continuous or contiguous) subcarriers in frequency domain, and/or a slot, or mini-slot, or symbol time interval in time domain.

Signaling may in general comprise one or more symbols having a symbol time length, the symbol time length being dependent on a numerology.

Signaling may pertain to a specific transmission timing structure, e.g. a slot or mini-slot. Different signalings may pertain to the same transmission timing structure.

There is also discussed a program product comprising instructions causing processing circuitry to control and/or perform a method as described herein.

Moreover, a carrier medium arrangement carrying and/or storing a program product as described herein may be considered.

The radio node may be a user equipment or a network node, in particular a base station or gNodeB or eNodeB. Signaling may be downlink signaling, or uplink or sidelink signaling. A transmitting radio node may in particular be a user equipment. A transmission parametrisation or transmission configuration may be considered a specific form of configuration.

Generally, it may be considered to separate different signalings (e.g., users and/or node and/or data streams and/or channels) in separate (e.g., orthogonal) resource subsets, and to provide non-orthogonal transmission within each subset.

A set of resources may generally represent resources available and/or scheduled for non-orthogonal transmission, e.g. pertaining to a specific set of signalings, and/or a specific set of radio nodes, e.g. user equipments (UEs).

According to the approaches described herein, non-orthogonal transmission is simplified, limiting overhead. For example, parametrisation vectors may be smaller/shorter, reducing constellation cardinality and/or complexity.

It should be noted that both sides of a communication (transmitter and receiver) may be configured with indications of the parametrisation vector and/or group vectors associated to specific signalings, and/or with the resources/subset of resources associated thereto.

The approaches described herein are particularly useful in the context of multi-user/multi-signaling scenarios, e.g. for Machine-Type-Communication/M2M communications, for example, if the number of signalings/radio nodes is larger than the number of available orthogonal vectors. Also, for some low latency scenarios, e.g. URLLC (Ultra-Reliable Low Latency Communication), the approaches may be particularly suitably implemented. In such cases, one or more radio nodes/UEs may be configured with non-orthogonal transmission configurations, which may be usable independently of specific scheduling, e.g. event-driven.

### BRIEF DESCRIPTION OF THE DRAWINGS

The drawings are provided to illustrate concepts and approaches described herein, and are not intended to limit their scope. The drawings comprise:

FIG. 1, showing examples of NOMA signaling;

FIG. 2, showing an example matrix of NOMA signaling;

FIG. 3, showing an exemplary radio node, e.g. implemented as UE or terminal; and

FIG. 4, showing an exemplary radio node, e.g. implemented as network node or base station.

### DETAILED DESCRIPTION

In the following, non-orthogonal signaling approaches are discussed, exemplarily for multiple access (multiple radio nodes, e.g. user equipments, transmitting to a network node) and/or uplink. However, the approaches are applicable to signaling by one node as well, e.g. for a network node in downlink, in which the approaches may be considered to represent multiplexing (multiplexing may also be considered in uplink, or in sidelink). Accordingly, while there may be referred to non-orthogonal Multiple Access schemes, this may be considered to be applicable mutatis mutandis to non-orthogonal multiplexing, in particular for downlink signaling.

NoMA schemes are generally based on modulation and spreading methods that map the user data on resources that are shared among multiple users.

In NOMA, UE transmissions are overlapping on shared time and frequency resources, by using properly designed sequences/vectors in order to spread the information symbols in frequency. This preprocessing is carried out by repeating the M-QAM information symbols (M representing the cardinality of modulation, e.g. 8, 16, 32, 64, 128 or 256) over a number of contiguous or continuously (in frequency domain) arranged resource elements (REs), yet each with different weight and phase (different group vectors). Clever design of spreading vectors (representing parametrisation vectors) can facilitate the implementation of advanced multi-user detectors (MUD), such as the minimum-mean squared-error (MMSE) detector or the maximum a posteriori (MAP) detector, in order to improve the joint detection/demodulation of the superimposed UE transmissions. The system can then achieve enhanced performance, in terms of sum-rate and/or number of supported UEs, when NOMA-enabled UEs are sharing the time/frequency resources and effective MUD solutions are used to separate their data signals.

The complexity of the optimal multi-user detection for NoMA UEs, namely that of MAP receiver, grows exponentially with the constellation cardinality £ and the number K of UEs as O(£^{K}). Therefore, for most practical cases suboptimal detection such as message passing algorithm or MMSE is employed, which has moderate complexity and sub-optimal performance.

Generally, there may be considered
1. Dividing the available resources for non-orthogonal multiple access into smaller orthogonal sub-sets, and within each subset the UEs operate in a non-orthogonal fashion; and/or
2. Spreading users such that they have non-zero elements only on one or multiple of those subsets; and/or
3. Applying multi-user detection separately, on the subsets.

The proposed approaches provide a spreading technique that makes optimal multiuser detection affordable in terms of complexity.

The proposed approaches allow the scheduler (e.g., network node) to control the UE assignment/pairing, onto the subsets, such that the desired performance targets can be achieved.

Available resources (a set of resources) for non-orthogonal multiple access may be divided into smaller orthogonal sub-sets of resources, e.g. non-overlapping in time and/or frequency. Within each such orthogonal resource, comprising a number of REs, the UE QAM symbols are spread using non-orthogonal spreading vectors. It should be noted that orthogonal transmission/resources allow easy separation/detection of signaling, whereas non-orthogonal transmission is performed on potentially shared time/frequency resources.

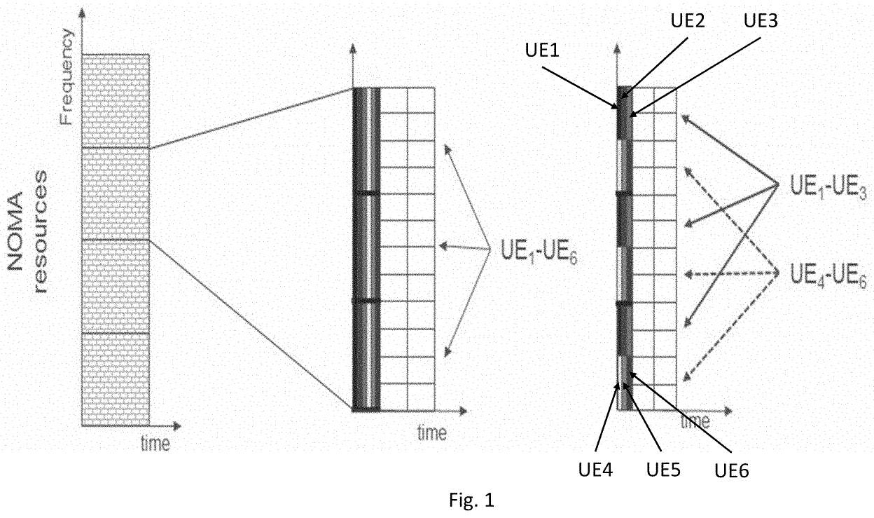

FIG. 1 shows an example of transmission within resources, shown in the left part of the figure, that are released/scheduled for NOMA. In this toy example, it is assumed the set of resources comprised 4 PRBs, the number k of UEs is K=6 UEs. Two ways of spreading their symbols are discussed.

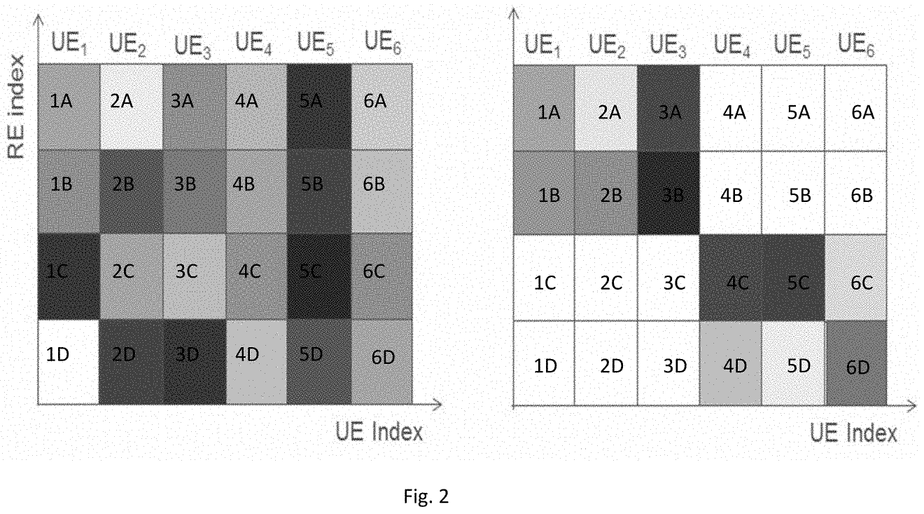

In the middle part of FIG. 1, all 6 UEs are transmitting over N=4 REs (in the same resource block) for each symbol (such that each symbol is spread out over for REs, to each RE and symbol there being associated a different group vector, 4REs representing one subset). This spreading scheme is shown in more detail, for one transmitted QAM symbol, in FIG. 2 (left). An exemplary spreading matrix is given in Table 1.

In the right part of FIG. 1, the resources are divided into two orthogonal sets (subsets, each representing of length 2 REs each. Within each subset, three UEs are spread using a non-orthogonal spreading matrix or vector (parametrisation vector) of length 2 (N=2 REs, it should be noted that the group vectors herein have length 1, the length of a vector referred herein indicating the number of resource elements it extends over). This spreading scheme is shown in more detail, for one transmitted QAM symbol, in FIG. 2 (right). An example spreading matrix is given in Table 2.

TABLE 1
Example of spreading matrix for 4-by-6 NOMA

| | | | | | |
|---|---|---|---|---|---|
| 0.5 + 0.0 i | 0.5 + 0.0 i | 0.5 + 0.0 i | 0.5 + 0.0 i | 0.5 + 0.0 i | 0.5 + 0.0 i |
| 0.0 + 0.5 i | 0.5 + 0.0 i | 0.0 + 0.5 i | 0.0 + 0.5 i | 0.0 + −0.5 i | 0.0 + −0.5 i |
| −0.5 + 0.0 i | 0.0 + 0.5 i | 0.0 + −0.5 i | 0.0 + 0.5 i | −0.5 + 0.0 i | 0.0 + 0.5 i |
| 0.0 + 0.5 i | 0.0 + −0.5 i | 0.5 + 0.0 i | −0.5 + 0.0 i | 0.0 + −0.5 i | 0.5 + 0.0 i |

TABLE 2
Example of spreading matrix for 2-by-3 NOMA

| | | |
|---|---|---|
| 0.5 + 0.0 i | 0.5 + 0.0 i | 0.0 + 0.5 i |
| 0.0 + 0.5 i | 0.5 + 0.0 i | 0.0 + −0.5 i |

In this example, the overloading factor ρ≙K/N, which is the ratio between the number of UEs and the length of the spreading vectors, or the number of occupied resource elements, is in both cases 150% (6/4 and 3/2, respectively). Hence, both spreading schemes have the same spectral efficiency (each UE sends three QAM symbols within a PRB, each being spread over different number of REs in the left or right) and support the same number of UEs (6 UEs within each PRB). However, the method on the right side makes it possible to perform MAP detection between the 3 overlapping UEs. The reason is that for K=3 (even for K=4 that yields p=200%), the MAP complexity is manageable for certain constellations. It should be noted that symbols transmitted in the same resource element (or associated symbol time interval) are transmitted simultaneously. The order of transmission within the symbol time interval/RE in the figures is due to constraints of illustration. A shown, a group of UEs (representing different signalings) is divided into two subgroups, which are mapped to different subsets of resources.

The partitioning into two groups, using length-2 spreading within each group, can be seen as a special case of the length-4 spreading. A length-2 vector can be viewed as a length-4 vector whose two last elements are set to zero for UE₁-UE₃ (equivalently the two first elements are set to zero for UE₄-UE₆). Therefore, the network node or gNB has some flexibility into assigning the UEs into sub-groups depending on their coverage (SNR) or other channel conditions.

In another example, the value of N can be different, e.g. it can be N=6 or 12. In this case, the UEs may be into 3 subsets (equivalently into 6 subsets for N=12), where length-2 or length-4 spreading vectors may be used within a subset.

In one variant, the UEs derive their spreading vectors via a seed that is sent by the gNB. The seed may be considered to represent configuration data.

In some implementations, the gNB employs MMSE detection on the length-2 vectors.

In one configuration, the length-2 vectors are different in the different sub-sets.

In one configuration, the length-2 vectors are the same in the different sub-sets.

In one variant, the NOMA spreading vectors/matrices are designed to achieve, with equality, the Welch bound, which is a bound on the sum of squares of the cross-correlations of a set of vectors. The parametrisation vectors/associated group vectors of a set of transmission configurations may be defined accordingly.

In some implementations, time/frequency interleaving is performed on the NOMA-spread QAM symbols. This may comprise frequency and/or time hopping and/or exchanging symbols of different signaling after applying the associated group vector.

In one variant or configuration, the length of vectors in different subsets may be different, for example N=6, with parametrisation vector lengths divided into 2 and 4 long vectors (group vectors may still have length of 1, such that a symbol is mapped to/transmitted on one RE).

FIG. 1 shows NOMA resources comprising a set of PRBs, and UE spreading within a PRB. In the middle, all 6 UEs are spread using length-4 vectors. In the right part, UE₁-UE₃ are spread onto RE-pairs with indices {(1,2), (5,6), (9,10)} using length-2 vectors, whereas UE₄-UE₆ are spread onto RE-pairs with indices {(3,4), (7,8), (11,12)} using (the same or different) length-2 vectors. In both cases, each UE sends 3 QAM symbols/PRB and we accommodate 6 UEs/PRB. A QAM symbol may be considered an example of a symbol which is a modulated symbol.

FIG. 2 shows an example of a NoMA spreading matrix. On the left, 6 UEs are spread onto 4 REs each. On the right, 6 UEs are partitioned into two groups of 3 UEs that are spread onto 2 REs each. The length-2 spreading vectors maybe identical or different for the two subsets. Each group of UEs are associated to a different subset of resources (in particular, frequency resources), whereas within each group/subset, symbols for each UE (respectively, associated signaling) are transmitted on the same frequencies and simultaneously. Non-orthogonality within each group is achieved based on the selection of spreading vectors/associated group vectors.

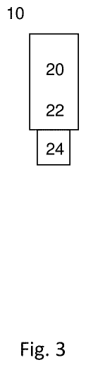

FIG. 3 schematically shows a radio node, in particular a terminal or wireless device 10, which may in particular be implemented as a UE (User Equipment). Radio node 10 comprises processing circuitry (which may also be referred to as control circuitry) 20, which may comprise a controller connected to a memory. Any module of the radio node 10, e.g. a communicating module or determining module, may be implemented in and/or executable by, the processing circuitry 20, in particular as module in the controller. Radio node 10 also comprises radio circuitry 22 providing receiving and transmitting or transceiving functionality (e.g., one or more transmitters and/or receivers and/or transceivers), the radio circuitry 22 being connected or connectable to the processing circuitry. An antenna circuitry 24 of the radio node 10 is connected or connectable to the radio circuitry 22 to collect or send and/or amplify signals. Radio circuitry 22 and the processing circuitry 20 controlling it are configured for cellular communication with a network, e.g. a RAN as described herein, and/or for sidelink communication. Radio node 10 may generally be adapted to carry out any of the methods of operating a radio node like terminal or UE disclosed herein; in particular, it may comprise corresponding circuitry, e.g. processing circuitry, and/or modules.

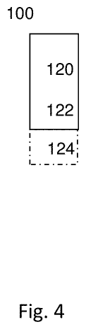

FIG. 4 schematically show a radio node 100, which may in particular be implemented as a network node 100, for example an eNB or gNB or similar for NR. Radio node 100 comprises processing circuitry (which may also be referred to as control circuitry) 120, which may comprise a controller connected to a memory. Any module, e.g. transmitting module and/or receiving module and/or configuring module of the node 100 may be implemented in and/or executable by the processing circuitry 120. The processing circuitry 120 is connected to control radio circuitry 122 of the node 100, which provides receiver and transmitter and/or transceiver functionality (e.g., comprising one or more transmitters and/or receivers and/or transceivers). An antenna circuitry 124 may be connected or connectable to radio circuitry 122 for signal reception or transmittance and/or amplification. Node 100 may be adapted to carry out any of the methods for operating a radio node or network node disclosed herein; in particular, it may comprise corresponding circuitry, e.g. processing circuitry, and/or modules. The antenna circuitry 124 may be connected to and/or comprise an antenna array. The node 100, respectively its circuitry, may be adapted to perform any of the methods of operating a network node or a radio node as described herein.

There is generally considered a program product comprising instructions adapted for causing processing and/or control circuitry to carry out and/or control any method described herein, in particular when executed on the processing and/or control circuitry. Also, there is considered a carrier medium arrangement carrying and/or storing a program product as described herein.

A carrier medium arrangement may comprise one or more carrier media. Generally, a carrier medium may be accessible and/or readable and/or receivable by processing or control circuitry. Storing data and/or a program product and/or code may be seen as part of carrying data and/or a program product and/or code. A carrier medium generally may comprise a guiding/transporting medium and/or a storage medium. A guiding/transporting medium may be adapted to carry and/or carry and/or store signals, in particular electromagnetic signals and/or electrical signals and/or magnetic signals and/or optical signals. A carrier medium, in particular a guiding/transporting medium, may be adapted to guide such signals to carry them. A carrier medium, in particular a guiding/transporting medium, may comprise the electromagnetic field, e.g. radio waves or microwaves, and/or optically transmissive material, e.g. glass fiber, and/or cable. A storage medium may comprise at least one of a memory, which may be volatile or non-volatile, a buffer, a cache, an optical disc, magnetic memory, flash memory, etc.

In general, a numerology and/or subcarrier spacing may indicate the bandwidth (in frequency domain) of a subcarrier of a carrier, and/or the number of subcarriers in a carrier and/or the numbering of the subcarriers in a carrier. Different numerologies may in particular be different in the bandwidth of a subcarrier. In some variants, all the subcarriers in a carrier have the same bandwidth associated to them. The numerology and/or subcarrier spacing may be different between carriers in particular regarding the subcarrier bandwidth. A symbol time length, and/or a time length of a timing structure pertaining to a carrier may be dependent on the carrier frequency, and/or the subcarrier spacing and/or the numerology. In particular, different numerologies may have different symbol time lengths.

Signaling may generally comprise one or more symbols and/or signals and/or messages. A signal may comprise one or more bits. An indication may represent signaling, and/or be implemented as a signal, or as a plurality of signals. One or more signals may be included in and/or represented by a message. Signaling, in particular control signaling, may comprise a plurality of signals and/or messages, which may be transmitted on different carriers and/or be associated to different signaling processes, e.g. representing and/or pertaining to one or more such processes and/or corresponding information. An indication may comprise signaling, and/or a plurality of signals and/or messages and/or may be comprised therein, which may be transmitted on different carriers and/or be associated to different acknowledgement signaling processes, e.g. representing and/or pertaining to one or more such processes.

Uplink or sidelink signaling may be OFDMA (Orthogonal Frequency Division Multiple Access) or SC-FDMA (Single Carrier Frequency Division Multiple Access) signaling. Downlink signaling may in particular be OFDMA signaling. However, signaling is not limited thereto (Filter-Bank based signaling may be considered one alternative).

Different formats of for control information or control signaling may be considered, e.g. different formats for a control channel like a Physical Uplink Control Channel (PUCCH). PUCCH may carry control information or corresponding control signaling, e.g. Uplink Control Information (UCI), which may comprise acknowledgement signaling like HARQ feedback (ACK/NACK), and/or Channel Quality Information (CQI), and/or Scheduling Request (SR). One of the supported PUCCH formats may be short, and may e.g. occur at the end of a slot interval. Similar control information may be provided on a sidelink, e.g. as Sidelink Control Information (SCI), in particular on a (physical) sidelink control channel, like a (P)SCCH.

A radio node may generally be considered a device or node adapted for wireless and/or radio (and/or microwave) frequency communication, and/or for communication utilising an air interface, e.g. according to a communication standard.

A radio node may be a network node, or a user equipment or terminal. A network node may be any radio node of a wireless communication network, e.g. a base station and/or gNodeB (gNB) and/or eNodeB (eNB) and/or relay node and/or micro/nano/pico/femto node and/or other node, in particular for a RAN as described herein.

The terms wireless device, user equipment (UE) and terminal may be considered to be interchangeable in the context of this disclosure. A wireless device, user equipment or terminal may represent an end device for communication utilising the wireless communication network, and/or be implemented as a user equipment according to a standard. Examples of user equipments may comprise a phone like a smartphone, a personal communication device, a mobile phone or terminal, a computer, in particular laptop, a sensor or machine with radio capability (and/or adapted for the air interface), in particular for MTC (Machine-Type-Communication, sometimes also referred to M2M, Machine-To-Machine), or a vehicle adapted for wireless communication. A user equipment or terminal may be mobile or stationary.

A radio node may generally comprise processing circuitry and/or radio circuitry. Circuitry may comprise integrated circuitry. Processing circuitry may comprise one or more processors and/or controllers (e.g., microcontrollers), and/or ASICs (Application Specific Integrated Circuitry) and/or FPGAs (Field Programmable Gate Array), or similar. It may be considered that processing circuitry comprises, and/or is (operatively) connected or connectable to one or more memories or memory arrangements. A memory arrangement may comprise one or more memories. A memory may be adapted to store digital information. Examples for memories comprise volatile and non-volatile memory, and/or Random Access Memory (RAM), and/or Read-Only-Memory (ROM), and/or magnetic and/or optical memory, and/or flash memory, and/or hard disk memory, and/or EPROM or EEPROM (Erasable Programmable ROM or Electrically Erasable Programmable ROM). Radio circuitry may comprise one or more transmitters and/or receivers and/or transceivers (a transceiver may operate or be operable as transmitter and receiver, and/or may comprise joint or separated circuitry for receiving and transmitting, e.g. in one package or housing), and/or may comprise one or more amplifiers and/or oscillators and/or filters, and/or may comprise, and/or be connected or connectable to antenna circuitry and/or one or more antennas.

Any one or all of the modules disclosed herein may be implemented in software and/or firmware and/or hardware. Different modules may be associated to different components of a radio node, e.g. different circuitries or different parts of a circuitry. It may be considered that a module is distributed over different components and/or circuitries. A program product as described herein may comprise the modules related to a device on which the program product is intended (e.g., a user equipment or network node) to be executed (the execution may be performed on the associated circuitry).

A radio access network may be a wireless communication network, and/or a Radio Access Network (RAN) in particular according to a communication standard. A communication standard may in particular a standard according to 3GPP and/or 5G, e.g. according to NR or LTE, in particular LTE Evolution.

A wireless communication network may be and/or comprise a Radio Access Network (RAN), which may be and/or comprise any kind of cellular and/or wireless radio network, which may be connected or connectable to a core network. The approaches described herein are particularly suitable for a 5G network, e.g. LTE Evolution and/or NR (New Radio), respectively successors thereof. A RAN may comprise one or more network nodes. A network node may in particular be a radio node adapted for radio and/or wireless and/or cellular communication with one or more terminals. A terminal may be any device adapted for radio and/or wireless and/or cellular communication with or within a RAN, e.g. a user equipment (UE) or mobile phone or smartphone or computing device or vehicular communication device or device for machine-type-communication (MTC), etc. A terminal may be mobile, or in some cases stationary.

Transmitting in downlink may pertain to transmission from the network or network node to the terminal. Transmitting in uplink may pertain to transmission from the terminal to the network or network node. Transmitting in sidelink may pertain to (direct) transmission from on terminal to another. Uplink, downlink and sidelink (e.g., sidelink transmission and reception) may be considered communication directions.

Signaling may generally comprise one or more signals and/or one or more symbols. Control information or a control information message or corresponding signaling (control signaling) may be transmitted on a control channel, e.g. a physical control channel, which may be a downlink channel or (or a sidelink channel in some cases, e.g. one UE scheduling another UE). For example, control information/allocation information may be signaled by a network node on PDCCH (Physical Downlink Control Channel) and/or a PDSCH (Physical Downlink Shared Channel) and/or a HARQ-specific channel. Acknowledgement signaling, e.g. as a form of uplink control information, may be transmitted by a terminal on a PUCCH (Physical Uplink Control Channel) and/or PUSCH (Physical Uplink Shared Channel) and/or a HARQ-specific channel. Multiple channels may apply for multi-component/multi-carrier indication or signaling. Signaling may be associated to a communication, which may represent transmitting and/or receiving between two radio nodes.

Transmitting signaling may comprise encoding and/or modulating. Encoding and/or modulating may comprise error detection coding and/or forward error correction encoding and/or scrambling. Modulating may comprise, and/or be followed by transforming a modulated symbol, e.g. by applying a group vector and/or spreading the symbol on more than one resource groups, e.g. applying a group vector for each resource group. Receiving signaling may comprise corresponding decoding and/or demodulation (which may following dispreading and/or detransformation).

A (modulated symbol) may generally indicate an information content, which represent a number of bits, e.g. depending on the form of modulation used. The exact combination of bit values represented by a (modulated) symbol may indicated by its constellation, which may represent a point in a constellation diagram, e.g. representing real and imaginary carrier components.

References to specific resource structures like transmission timing structure and/or symbol and/or slot and/or mini-slot and/or subcarrier and/or carrier may pertain to a specific numerology, which may be predefined and/or configured or configurable. A transmission timing structure may represent a time interval, which may cover one or more symbols. Some examples of a transmission timing structure are subframe, slot and mini-slot. A slot may comprise a predetermined, e.g. predefined and/or configured or configurable, number of symbols, e.g. 6 or 7, or 12 or 14. A mini-slot may comprise a number of symbols (which may in particular be configurable or configured) smaller than the number of symbols of a slot, in particular 1, 2, 3 or 4 symbols. A transmission timing structure may cover a time interval of a specific length, which may be dependent on symbol time length and/or cyclic prefix used. A transmission timing structure may pertain to, and/or cover, a specific time interval in a time stream, e.g. synchronized for communication. Timing structures used and/or scheduled for transmission, e.g. slot and/or mini-slots, may be scheduled in relation to, and/or synchronized to, a timing structure provided and/or defined by other transmission timing structures. Such transmission timing structures may define a timing grid, e.g., with symbol time intervals within individual structures representing the smallest timing units. Such a timing grid may for example be defined by slots or subframes (wherein in some cases, subframes may be considered specific variants of slots). A transmission timing structure may have a duration (length in time) determined based on the durations of its symbols, possibly in addition to cyclic prefix/es used. The symbols of a transmission timing structure may have the same duration, or may in some variants have different duration. The number of symbols in a transmission timing structure may be predefined and/or configured or configurable, and/or be dependent on numerology.

An indication generally may explicitly and/or implicitly indicate the information it represents and/or indicates. Implicit indication may for example be based on position and/or resource used for transmission. Explicit indication may for example be based on a parametrisation with one or more parameters, and/or one or more index or indices, and/or one or more bit patterns representing the information. It may in particular be considered that control signaling as described herein, based on the utilised resource sequence, implicitly indicates the control signaling type.

A resource element may generally describe the smallest individually usable and/or encodable and/or decodable and/or modulatable and/or demodulatable time-frequency resource, and/or may describe a time-frequency resource covering a symbol time length in time and a subcarrier in frequency. A signal may be allocatable and/or allocated to a resource element. A subcarrier may be a subband of a carrier, e.g. as defined by a standard. A carrier may define a frequency and/or frequency band for transmission and/or reception. In some variants, a signal (jointly encoded/modulated) may cover more than one resource elements. A resource element may generally be as defined by a corresponding standard, e.g. NR or LTE. As symbol time length and/or subcarrier spacing (and/or numerology) may be different between different symbols and/or subcarriers, different resource elements may have different extension (length/width) in time and/or frequency domain, in particular resource elements pertaining to different carriers.

A resource generally may represent a time-frequency and/or code resource, on which signaling, e.g. according to a specific format, may be communicated, for example transmitted and/or received, and/or be intended for transmission and/or reception.

Configuring a radio node, in particular a terminal or user equipment, may refer to the radio node being adapted or caused or set to operate according to the configuration. Configuring may be done by another device, e.g., a network node (for example, a radio node of the network like a base station or eNodeB) or network, in which case it may comprise transmitting configuration data to the radio node to be configured. Such configuration data may represent the configuration to be configured and/or comprise one or more instruction pertaining to a configuration, e.g. a configuration for transmitting and/or receiving on allocated resources, in particular frequency resources. A radio node may configure itself, e.g., based on configuration data received from a network or network node. A network node may utilise, and/or be adapted to utilise, its circuitry/ies for configuring. Allocation information may be considered a form of configuration data.

Generally, configuring may include determining configuration data representing the configuration and providing it to one or more other nodes (parallel and/or sequentially), which may transmit it further to the radio node (or another node, which may be repeated until it reaches the wireless device). Alternatively, or additionally, configuring a radio node, e.g., by a network node or other device, may include receiving configuration data and/or data pertaining to configuration data, e.g., from another node like a network node, which may be a higher-level node of the network, and/or transmitting received configuration data to the radio node. Accordingly, determining a configuration and transmitting the configuration data to the radio node may be performed by different network nodes or entities, which may be able to communicate via a suitable interface, e.g., an X2 interface in the case of LTE or a corresponding interface for NR. Configuring a terminal may comprise scheduling downlink and/or uplink transmissions for the terminal, e.g. downlink data and/or downlink control signaling and/or DCI and/or uplink signaling, in particular acknowledgement signaling, and/or configuring resources and/or a resource pool therefor.

A carrier may generally represent a frequency range or band and/or pertain to a central frequency and an associated frequency interval. It may be considered that a carrier comprises a plurality of subcarriers. A carrier may have assigned to it a central frequency or center frequency interval, e.g. represented by one or more subcarriers (to each subcarrier there may be generally assigned a frequency bandwidth or interval).

Different carriers may be non-overlapping, and/or may be neighboring in frequency domain.

It should be noted that the term “radio” in this disclosure may be considered to pertain to wireless communication in general, and may also include wireless communication utilising microwave and/or millimeter and/or other frequencies, in particular between 100 MHz or 1 GHz, and 100 GHz or 20 or 10 GHz. Such communication may utilise one or more carriers.

A radio node, in particular a network node or a terminal, may generally be any device adapted for transmitting and/or receiving radio and/or wireless signals and/or data, in particular communication data, in particular on at least one carrier. The at least one carrier may comprise a carrier accessed based on a LBT procedure (which may be called LBT carrier), e.g., an unlicensed carrier. It may be considered that the carrier is part of a carrier aggregate.

Receiving or transmitting on a cell or carrier may refer to receiving or transmitting utilizing a frequency (band) or spectrum associated to the cell or carrier. A cell may generally comprise and/or be defined by or for one or more carriers, in particular at least one carrier for UL communication/transmission (called UL carrier) and at least one carrier for DL communication/transmission (called DL carrier). It may be considered that a cell comprises different numbers of UL carriers and DL carriers. Alternatively, or additionally, a cell may comprise at least one carrier for UL communication/transmission and DL communication/transmission, e.g., in TDD-based approaches.

A channel may generally be a logical, transport or physical channel. A channel may comprise and/or be arranged on one or more carriers, in particular a plurality of subcarriers. A channel carrying and/or for carrying control signaling/control information may be considered a control channel, in particular if it is a physical layer channel.

In general, a symbol may represent and/or be associated to a symbol time length, which may be dependent on the carrier and/or subcarrier spacing and/or numerology of the associated carrier. Accordingly, a symbol may be considered to indicate a time interval having a symbol time length in relation to frequency domain. A symbol time length may be dependent on a carrier frequency and/or bandwidth and/or numerology and/or subcarrier spacing of or associated to a symbol. Accordingly, different symbols may have different symbol time lengths.

A sidelink may generally represent a communication channel (or channel structure) between two UEs and/or terminals, in which data is transmitted between the participants (UEs and/or terminals) via the communication channel, e.g. directly and/or without being relayed via a network node. A sidelink may be established only and/or directly via air interface/s of the participant, which may be directly linked via the sidelink communication channel. In some variants, sidelink communication may be performed without interaction by a network node, e.g. on fixedly defined resources and/or on resources negotiated between the participants. Alternatively, or additionally, it may be considered that a network node provides some control functionality, e.g. by configuring resources, in particular one or more resource pool/s, for sidelink communication, and/or monitoring a sidelink, e.g. for charging purposes.

Sidelink communication may also be referred to as device-to-device (D2D) communication, and/or in some cases as ProSe (Proximity Services) communication, e.g. in the context of LTE. A sidelink may be implemented in the context of V2x communication (Vehicular communication), e.g. V2V (Vehicle-to-Vehicle), V2I (Vehicle-to-Infrastructure) and/or V2P (Vehicle-to-Person). Any device adapted for sidelink communication may be considered a user equipment or terminal.

A sidelink communication channel (or structure) may comprise one or more (e.g., physical or logical) channels, e.g. a PSCCH (Physical Sidelink Control CHannel, which may for example carry control information like an acknowledgement position indication, and/or a PSSCH (Physical Sidelink Shared CHannel, which for example may carry data and/or acknowledgement signaling). It may be considered that a sidelink communication channel (or structure) pertains to and/or used one or more carrier/s and/or frequency range/s associated to, and/or being used by, cellular communication, e.g. according to a specific license and/or standard. Participants may share a (physical) channel and/or resources, in particular in frequency domain and/or related to a frequency resource like a carrier) of a sidelink, such that two or more participants transmit thereon, e.g. simultaneously, and/or time-shifted, and/or there may be associated specific channels and/or resources to specific participants, so that for example only one participant transmits on a specific channel or on a specific resource or specific resources, e.g., in frequency domain and/or related to one or more carriers or subcarriers.

A sidelink may comply with, and/or be implemented according to, a specific standard, e.g. a LTE-based standard and/or NR. A sidelink may utilise TDD (Time Division Duplex) and/or FDD (Frequency Division Duplex) technology, e.g. as configured by a network node, and/or preconfigured and/or negotiated between the participants. A user equipment may be considered to be adapted for sidelink communication if it, and/or its radio circuitry and/or processing circuitry, is adapted for utilising a sidelink, e.g. on one or more frequency ranges and/or carriers and/or in one or more formats, in particular according to a specific standard. It may be generally considered that a Radio Access Network is defined by two participants of a sidelink communication. Alternatively, or additionally, a Radio Access Network may be represented, and/or defined with, and/or be related to a network node and/or communication with such a node.

Communication or communicating may generally comprise transmitting and/or receiving signaling. Communication on a sidelink (or sidelink signaling) may comprise utilising the sidelink for communication (respectively, for signaling). Sidelink transmission and/or transmitting on a sidelink may be considered to comprise transmission utilising the sidelink, e.g. associated resources and/or transmission formats and/or circuitry and/or the air interface. Sidelink reception and/or receiving on a sidelink may be considered to comprise reception utilising the sidelink, e.g. associated resources and/or transmission formats and/or circuitry and/or the air interface. Sidelink control information (e.g., SCI) may generally be considered to comprise control information transmitted utilising a sidelink.

Generally, carrier aggregation (CA) may refer to the concept of a radio connection and/or communication link between a wireless and/or cellular communication network and/or network node and a terminal or on a sidelink comprising a plurality of carriers for at least one direction of transmission (e.g. DL and/or UL), as well as to the aggregate of carriers. A corresponding communication link may be referred to as carrier aggregated communication link or CA communication link; carriers in a carrier aggregate may be referred to as component carriers (CC). In such a link, data may be transmitted over more than one of the carriers and/or all the carriers of the carrier aggregation (the aggregate of carriers). A carrier aggregation may comprise one (or more) dedicated control carriers and/or primary carriers (which may e.g. be referred to as primary component carrier or PCC), over which control information may be transmitted, wherein the control information may refer to the primary carrier and other carriers, which may be referred to as secondary carriers (or secondary component carrier, SCC). However, in some approaches, control information may be send over more than one carrier of an aggregate, e.g. one or more PCCs and one PCC and one or more SCCs.

A transmission may generally pertain to a specific channel and/or specific resources, in particular with a starting symbol and ending symbol in time, covering the interval therebetween. A scheduled transmission may be a transmission scheduled and/or expected and/or for which resources are scheduled or provided or reserved. However, not every scheduled transmission has to be realized. For example, a scheduled downlink transmission may not be received, or a scheduled uplink transmission may not be transmitted due to power limitations, or other influences (e.g., a channel on an unlicensed carrier being occupied). A transmission may be scheduled for a transmission timing substructure (e.g., a mini-slot, and/or covering only a part of a transmission timing structure) within a transmission timing structure like a slot. A border symbol may be indicative of a symbol in the transmission timing structure at which the transmission starts or ends.

Predefined in the context of this disclosure may refer to the related information being defined for example in a standard, and/or being available without specific configuration from a network or network node, e.g. stored in memory, for example independent of being configured. Configured or configurable may be considered to pertain to the corresponding information being set/configured, e.g. by the network or a network node.

A scheduled transmission and/or mini-slot may pertain to a specific channel, in particular a physical uplink shared channel, a physical uplink control channel, or a physical downlink shared channel, e.g. PUSCH, PUCCH or PDSCH, and/or may pertain to a specific cell and/or carrier aggregation. A corresponding configuration, e.g. scheduling configuration or symbol configuration may pertain to such channel, cell and/or carrier aggregation.

A configuration may be a configuration indicating timing, and/or be represented or configured with corresponding configuration data. A configuration may be embedded in, and/or comprised in, a message or configuration or corresponding data, which may indicate and/or schedule resources, in particular semi-persistently and/or semi-statically.

The duration of a symbol of the transmission timing structure may generally be dependent on a numerology and/or carrier, wherein the numerology and/or carrier may be configurable. The numerology may be the numerology to be used for the scheduled transmission.

Scheduling a device, or for a device, and/or related transmission or signaling, may be considered comprising, or being a form of, configuring the device with resources, and/or of indicating to the device resources, e.g. to use for communicating. Scheduling may in particular pertain to a transmission timing structure, or a substructure thereof (e.g., a slot or a mini-slot, which may be considered a substructure of a slot). It may be considered that a border symbol may be identified and/or determined in relation to the transmission timing structure even if for a substructure being scheduled, e.g. if an underlying timing grid is defined based on the transmission timing structure. Signaling indicating scheduling may comprise corresponding scheduling information and/or be considered to represent or contain configuration data indicating the scheduled transmission and/or comprising scheduling information. Such configuration data or signaling may be considered a resource configuration or scheduling configuration. It should be noted that such a configuration (in particular as single message) in some cases may not be complete without other configuration data, e.g. configured with other signaling, e.g. higher layer signaling. In particular, the symbol configuration may be provided in addition to scheduling/resource configuration to identify exactly which symbols are assigned to a scheduled transmission. A scheduling (or resource) configuration may indicate transmission timing structure/s and/or resource amount (e.g., in number of symbols or length in time) for a scheduled transmission.

A scheduled transmission may be transmission scheduled, e.g. by the network or network node. Transmission may in this context may be uplink (UL) or downlink (DL) or sidelink (SL) transmission. A device, e.g. a user equipment, for which the scheduled transmission is scheduled, may accordingly be scheduled to receive (e.g., in DL or SL), or to transmit (e.g. in UL or SL) the scheduled transmission. Scheduling transmission may in particular be considered to comprise configuring a scheduled device with resource/s for this transmission, and/or informing the device that the transmission is intended and/or scheduled for some resources. A transmission may be scheduled to cover a time interval, in particular a successive number of symbols, which may form a continuous interval in time between (and including) a starting symbol and an ending symbols. The starting symbol and the ending symbol of a (e.g., scheduled) transmission may be within the same transmission timing structure, e.g. the same slot. However, in some cases, the ending symbol may be in a later transmission timing structure than the starting symbol, in particular a structure following in time. To a scheduled transmission, a duration may be associated and/or indicated, e.g. in a number of symbols or associated time intervals. In some variants, there may be different transmissions scheduled in the same transmission timing structure. A scheduled transmission may be considered to be associated to a specific channel, e.g. a shared channel like PUSCH or PDSCH.

A transmission timing structure may generally comprise a plurality of symbols defining the time domain extension (e.g., interval or length or duration) of the transmission timing structure, and arranged neighboring to each other in a numbered sequence. A timing structure (which may also be considered or implemented as synchronisation structure) may be defined by a succession of such transmission timing structures, which may for example define a timing grid with symbols representing the smallest grid structures. A transmission timing structure, and/or a border symbol or a scheduled transmission may be determined or scheduled in relation to such a timing grid. A transmission timing structure of reception may be the transmission timing structure in which the scheduling control signaling is received, e.g. in relation to the timing grid. A transmission timing structure may in particular be a slot or subframe or in some cases, a mini-slot.

In this disclosure, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other variants and variants that depart from these specific details.

For example, the concepts and variants are partially described in the context of Long Term Evolution (LTE) or LTE-Advanced (LTE-A) or New Radio mobile or wireless communications technologies; however, this does not rule out the use of the present concepts and aspects in connection with additional or alternative mobile communication technologies such as the Global System for Mobile Communications (GSM). While the variants may partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the variants described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. The aspects presented herein can be varied in many ways.

Approaches of spreading for non-orthogonal multiple access with low complexity and improved joint multi-user detection have been discussed in this disclosure.

| Abbreviation | Explanation |
|---|---|
| LTE | Long Term Evolution |
| MAP | Maximum a-posteriori |
| MMSE | Minimum Mean Squared Error |
| PRB | Physical Resource Block |
| NoMA | Non-orthogonal multiple access |
| NR | Next/New Radio |
| RE | Resource element |

1. A method of operating a radio node in a radio access network, the method comprising:
communicating based on a configuration, the configuration associating each signaling of a group of signalings with a subset of radio resources, each subset being a subset of a set of radio resources;
wherein a signaling associated to a subset of radio resources is associated to transmission that is non-orthogonal to transmission of other signaling associated to the same subset.

2. A radio node for a radio access network, the radio node comprising:
processing circuitry adapted to communicate based on a configuration, the configuration associating each signaling of a group of signalings with a subset of radio resources, each subset being a subset of a set of radio resources wherein a signaling associated to a subset of radio resources is associated to transmission that is non-orthogonal to transmission of other signaling associated to the same subset.

3. A method of operating a radio node in a radio access network, the method comprising:
transmitting signaling based on a transmission configuration, the transmission configuration indicating a subset of radio resources for transmitting the signaling, the subset being one subset of a plurality of subsets of a set of radio resources, the transmission configuration further indicating a transmission parametrisation for the signaling, the transmission parametrisation being one of a set of transmission parametrisations, wherein at least two of the transmission parametrisations are non-orthogonal to each other.

4. A radio node for a radio access network, the radio node comprising:
processing circuitry adapted to transmit signaling based on a transmission configuration, the transmission configuration indicating a subset of radio resources for transmitting the signaling, the subset being one subset of a plurality of subsets of a set of radio resources, the transmission configuration further indicating a transmission parametrisation for the signaling, the transmission parametrisation being one of a set of transmission parametrisations, wherein at least two of the transmission parametrisations are non-orthogonal to each other.

5. The method according to claim 1, wherein different subsets of radio resources are orthogonal to each other.

6. The method according to claim 1, wherein the radio resources are time/frequency resources.

7. The method according to claim 1, wherein a symbol of a signaling is spread over a plurality of resource elements.

8. The method according to claim 1, wherein a transmission parametrisation is indicated by a vector, which may be covering one or more subsets.

9. The method according to claim 1, wherein communicating comprises receiving the signalings utilising a MAP receiver.

10. The method according to claim 1, wherein a set of radio resources corresponds to a resource block, in particular a physical resource block.

11. The method according to claim 1, wherein the signaling comprises one or more symbols having a symbol time length, the symbol time length being dependent on a numerology.

12. (canceled)

13. (canceled)

14. The method according to claim 3, wherein different subsets of radio resources are orthogonal to each other.

15. The method according to claim 3, wherein the radio resources are time/frequency resources.

16. The method according to claim 3, wherein a symbol of a signaling is spread over a plurality of resource elements.

17. The method according to claim 3, wherein a transmission parametrisation is indicated by a vector, which may be covering one or more subsets.

18. The method according to claim 3, wherein communicating comprises receiving the signalings utilising a MAP receiver.

19. The method according to claim 3, wherein a set of radio resources corresponds to a resource block, in particular a physical resource block.

20. The method according to claim 3, wherein the signaling comprises one or more symbols having a symbol time length, the symbol time length being dependent on a numerology.
